(19) United States
(12) Patent Application Publication
(10) Pub. No.: US 2018/0139909 A1
(43) Pub. Date: May 24, 2018

(54) Plant Strap

(71) Applicant: NZ Tube Mills Ltd, Lower Hutt (NZ)

(72) Inventor: Paul Barnes, Lower Hutt (NZ)

(73) Assignee: NZ Tube Mills Ltd, Lower Hutt (NZ)

(21) Appl. No.: 15/798,800

(22) Filed: Oct. 31, 2017

(30) Foreign Application Priority Data
Nov. 22, 2016 (NZ) 726655

(51) Int. Cl. A01G 9/12

(52) U.S. Cl. CPC A01G 9/128; A01G 9/122

(57) ABSTRACT

In the field of horticulture plants can be exposed to winds or other damaging sideways forces. To supportively protect them it is known to tether a plant to a stake or the like. It is an object of a preferred form of the invention to go at least some way towards providing a convenient way of achieving this. Preferably this is achieved by a strap for connecting a plant to an elongate plant support, such as a stake. The strap has a pair of lobes each having a stake receiving aperture and central slits. A leading end of the strap has serrated edges. The strap is such that it can be bent back on itself so the stake receiving apertures align for receiving and gripping the stake, and so that the serrated edges engage one of the slits to form and maintain a plant holding loop.

### FIELD OF THE INVENTION

This invention relates to straps for use in supporting plants or parts thereof.

### BACKGROUND

In the field of horticulture plants can be exposed to winds or other damaging sideways forces. To supportively protect them it is known to tether a plant to a stake or the like. It is an object of a preferred form of the invention to go at least some way towards providing a convenient way of achieving this. It should however be understood that the object of the invention per se is simply to provide the public with useful choice, and so any objects or advantages of preferred embodiments should not be seen as limitations on claims expressed broadly.

The term “comprising” if and when used in this document in relation to a combination of features should not be taken to mean that the recited features are all that there can be. There may or may not be additional unspecified features.

### SUMMARY OF THE INVENTION

According to one aspect of the invention there is provided a strap for connecting a plant to an elongate plant support, the strap having at least two plant support receiving apertures, a central aperture and a serrated edge, the strap being such that it can be bent back on itself by hand in first and second zones such that:
a) at the first zone the plant support receiving apertures align for receiving and gripping the plant support; and
b) at the second zone part of the serrated edge engages the central aperture to form and maintain a plant holding loop.

Optionally there is more than one serrated edge and these are formed to simultaneously engage the central aperture.

Optionally the central aperture is in the form of a slit.

Optionally the slit extends longitudinally with respect to the rest of the strap.

Optionally the strap has two spaced lobes, each lobe having a respective one of the elongate plant support receiving apertures.

Optionally the strap is made substantially from rubber.

Optionally the strap has a second slit spaced from the first mentioned slit and extending longitudinally with respect to the rest of the strap, the second strip being adapted for engaging with the serrated edges.

Optionally the strap is fitted to an elongate plant support and plant, the strap bent so that the plant support receiving apertures are aligned and receive the elongate plant support and frictionally grip it, the strap being further bent so that the serrated edges extend through the central aperture to form and maintain a loop that tethers the plant to the elongate plant support.

Optionally the plant support is wider than the support receiving apertures when they are not in use, but resilience of the strap causes the support receiving apertures to stretch to fit snugly against the plant support.

Optionally the strap is such that:
a) the central aperture is in the form of a slit; and
b) the strap has two spaced lobes, each lobe having a respective one of the plant support receiving apertures.

Optionally the elongate plant support is upright.

Optionally the elongate plant support comprises a post.

Optionally the elongate plant support comprises a stake.

Optionally the strap is such that:
a) a first end having a pair of spaced lobes wherein each lobe has one of the receiving apertures;
b) a second end with serrations either side thereof; and
c) the central aperture is in the form of a slit aligned longitudinally with respect to the rest of the strap.

Use of the term “comprising” in relation to a combination of features should not be taken to exclude the option of there being further unspecified features. There may or may not be additional features and so the term should not be interpreted in a limiting sense.

### BRIEF DESCRIPTION OF THE DRAWINGS

Some preferred embodiments of the invention are illustrated in the following images, of which:

FIG. 1 is an isometric view of a plant support strap;

FIG. 2 is a plan view of the strap;

FIG. 3 is side view of the strap;

FIG. 4 is a photographic plan view of a further embodiment of the strap; and

FIG. 5 is a photographic view illustrating the strap of FIG. 4 in use with a plant stake;

FIG. 6 is an isometric view of a further plant strap; and

FIG. 7 is an isometric view of the FIG. 6 strap when fitted to a plant support stake.

### DETAILED DESCRIPTION

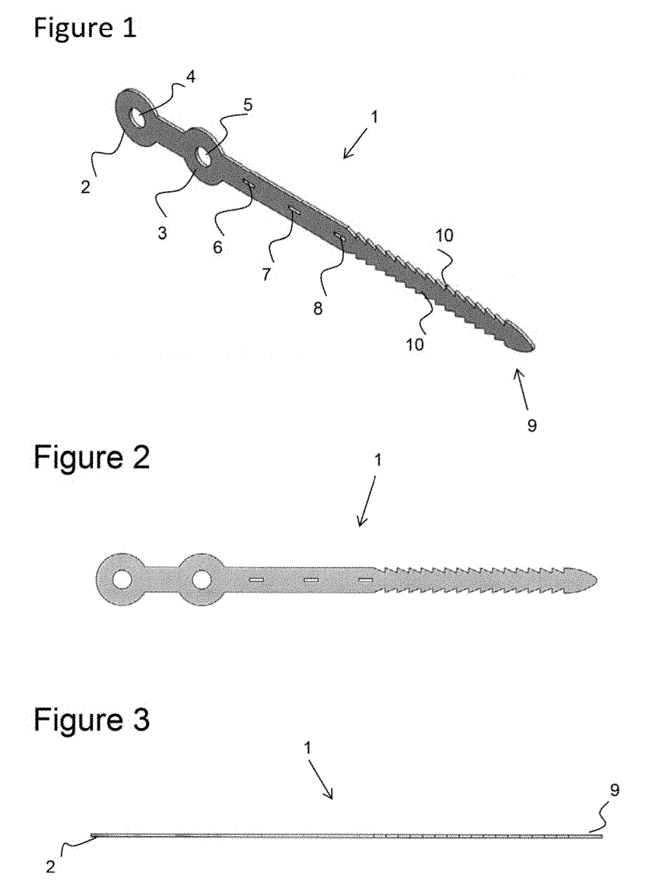

Referring to FIGS. 1, 2 and 3, the plant strap 1 is cut from relatively thin flexible rubber. At one end it has two spaced lobes 2, 3 each having a stake receiving aperture 4, 5. The strap also has central apertures in the form of slits 6, 7, 8 spaced from one another and running in the longitudinal direction of the strap and, beyond these, a strip 9 with serrations 10 either side.

The strap is sufficiently flexible so it can be bent at one end to cause the lobes 2, 3 to be more or less one above the other with the stake receiving apertures 4, 5 aligned. The strap can also be bent at the opposite end so the strip 9 forms a loop with its leading end passed through one of the slits 6, 7 and 8. The serrations 10 engage with the slit to keep the loop at the desired size. Bigger or smaller loops can be achieved by working with an alternative one of the slits. For example, selecting a slit further from the leading end of the strip 9 will result in a larger loop than would be created by selecting a closer slit. Alternatively the size of the loop can be adjusting by regulating the degree to which the leading end threads through the slit.

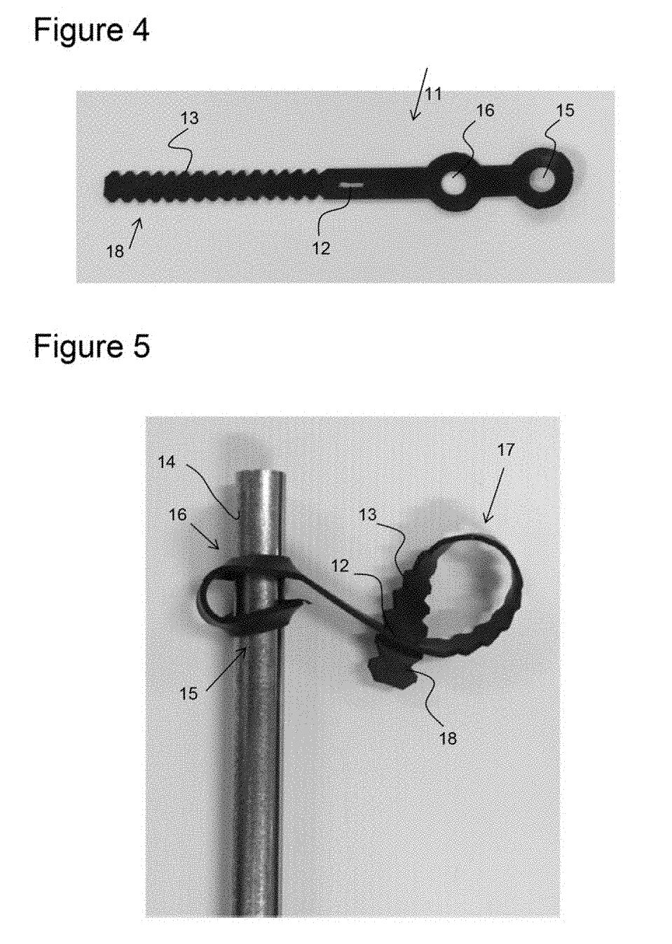

FIGS. 4 and 5 illustrate a strap 11 substantially the same as described above, except that it only has one central slit 12 and the serrations 13 are slightly less jagged.

As shown in FIG. 5, a plant stake 14 extending from the ground has been hand fitted with the lobed end of the strap. More specifically, the stake 14 extends through the apertures 15, 16 at the centre of the lobes to hold the strap reasonably tight against the stake. The tightness is a result of the apertures 15, 16 each being a little smaller than the width of the stake. Because the strap is formed of rubber and has a reasonable amount of resilience, the apertures expand to receive the stake, and squeeze against it to hold the strap in place. The strap can be moved along the stake by deliberate hand manipulation, but the fit is such that it does not slide freely.

FIG. 5 also illustrates a loop 17 formed at the other end of the strap for supporting the stem or a limb of a young plant (not shown) against wind or other potentially damaging sideways forces. In practice the loop 17 will extend completely around the stem or limb to tether the plant to the stake 14. The loop is formed in the way described above, namely the serrated strip 18 is threaded through the central slit 12 so that the serrations 13 engage the slit to maintain the loop. The serrations 13 are such that they create an interference-fit with the slit 12, albeit one which can be adjusted or broken with deliberate hand manipulation. The serrations 13 may be such that the width of the strip 18 alternates between being broader and narrower than the length of the slit 12. Broad parts occur where ridges of serrations align on opposite sides, and narrower parts occur where valleys of the serrations align on opposite sides. While the broader parts are slightly wider than the length of the slit, because the strap is made from resilient rubber the slit 12 can expand and a reasonably tight squeeze-fit created there.

The serrations 10 at FIG. 1 are similar in shape to ratchet teeth, and the serrations 13 of FIG. 5 are not so pointed or jagged. It should be understood that the term “serrated” as used in this document conveys an up and down edge profile sufficient to assist in maintaining the loop. The profile may be other than jagged or pointed, having reasonably curved ridges and valleys to provide the same or a similar function. References to serrations in this document should therefore be construed broadly and in context with the purpose they fulfil.

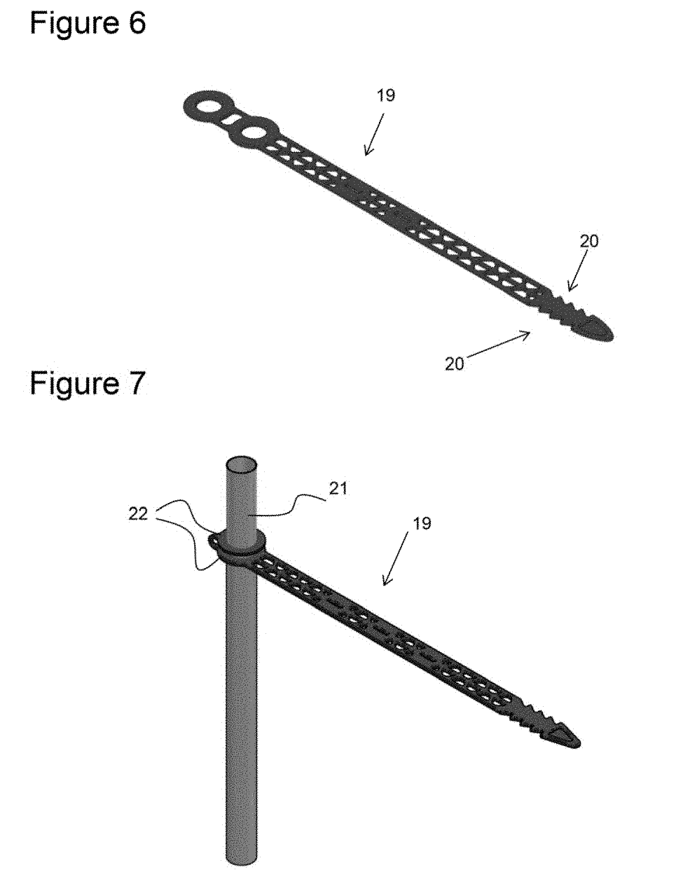

FIG. 6 illustrates a further embodiment of the invention, being a plant strap 19 for use in the same way described above. It is generally lattice-like so that less rubber or plastics, etc, is needed to produce it, and its leading serrated edges 20 extend for a shorter distance than in the FIG. 1 embodiment. FIG. 7 shows the strap when installed on a stake 21 by way of its aperture containing lobes 22, but not yet engaged with a plant.

While some embodiments of the invention have been described by way of example it should be appreciated that modifications and improvements can occur without departing from the scope of the following claims.

1. A strap for connecting a plant to an elongate plant support, the strap having at least two plant support receiving apertures, a central aperture and a serrated edge, the strap being such that it can be bent back on itself by hand in first and second zones such that:
at the first zone the plant support receiving apertures align for receiving and gripping the plant support; and
at the second zone part of the serrated edge engages the central aperture to form and maintain a plant holding loop.

2. A strap according to claim 1, wherein there is more than one serrated edge and these are formed to simultaneously engage the central aperture.

3. A strap according to claim 2, wherein the central aperture is in the form of a slit.

4. A strap according to claim 3, wherein the slit extends longitudinally with respect to the rest of the strap.

5. A strap according to claim 4, having two spaced lobes, each lobe having a respective one of the elongate plant support receiving apertures.

6. A strap according to claim 5, made substantially from rubber.

7. A strap according to claim 6, having a second slit spaced from the first mentioned slit and extending longitudinally with respect to the rest of the strap, the second strip being adapted for engaging with the serrated edges.

8. A strap according to claim 2, fitted to an elongate plant support and plant, the strap bent so that the plant support receiving apertures are aligned and receive the elongate plant support and frictionally grip it, the strap being further bent so that the serrated edges extend through the central aperture to form and maintain a loop that tethers the plant to the elongate plant support.

9. A strap according to claim 8, wherein the plant support is wider than the support receiving apertures when they are not in use, but resilience of the strap causes the support receiving apertures to stretch to fit snugly against the plant support.

10. A strap according to claim 9, wherein:
the central aperture is in the form of a slit; and
the strap has two spaced lobes, each lobe having a respective one of the plant support receiving apertures.

11. A strap according to claim 10, wherein the elongate plant support is upright.

12. A strap according to claim 11, wherein the elongate plant support comprises a post.

13. A strap according to claim 10, wherein the elongate plant support comprises a stake.

14. A strap according to claim 1, comprising:
a first end having a pair of spaced lobes wherein each lobe has one of the receiving apertures;
a second end with serrations either side thereof; and
the central aperture is in the form of a slit aligned longitudinally with respect to the rest of the strap.
